(19) United States
(12) Patent Application Publication
(10) Pub. No.: US 2012/0275742 A1
(43) Pub. Date: Nov. 1, 2012

(54) OPTICALLY-COUPLED DEVICE AND METHOD OF FIXING THE SAME

(76) Inventors: Michihiko NISHIGAKI, Kawasaki-shi (JP); Hideto Furuyama, Yokohama-shi (JP)

(21) Appl. No.: 13/415,033

(22) Filed: Mar. 8, 2012

(30) Foreign Application Priority Data
Apr. 28, 2011 (JP) 2011-102278

(51) Int. Cl. G02B 6/12

(52) U.S. Cl. 385/14

(57) ABSTRACT

According to one embodiment, an optically-coupled device includes a substrate and an optical fiber. The substrate is inclined from a first direction has a first width including a first surface optical device. The optical fiber is arranged in a second direction An end face has a second angle with respect to the first direction and has a radius of a second length. An outer edge of the end face of the optical fiber is it chamfered. A difference between the first angle and the second angle is not smaller than the difference with which the first surface optical device is protected from the end face of the optical fiber.

### CROSS-REFERENCE TO RELATED APPLICATIONS

This application is based upon and claims the benefit of priority from prior Japanese Patent Application No. 2011-102278, filed Apr. 28, 2011, the entire contents of which are incorporated herein by reference.

### FIELD

Embodiments described herein relate generally to an optically-coupled device applicable to a high-speed LSI package, an optical fiber cable and the like, for example.

### BACKGROUND

In recent years, an optical interconnection system using a light waveguide such as an optical fiber is suggested. In the light waveguide, there is substantially no frequency dependence property of loss from a direct current to a frequency of 100 [GHz] or larger and there is no electromagnetic disturbance such as noise by variation in grounding potential, so that it is possible to easily realize a wire of tens of [Gbps].

### BRIEF DESCRIPTION OF THE DRAWINGS

FIG. 1 is a cross-sectional view of an optically-coupled device according to a first embodiment;

FIG. 2 are cross-sectional views of a semiconductor substrate according to the first embodiment in which FIG. 2A is the cross-sectional view of the semiconductor substrate in which a circular mesa is formed of a second DBR and FIG. 2B is the cross-sectional view of the semiconductor substrate in which the circular mesa formed of a first DBR, an active layer, and the second DBR is formed;

FIG. 3 are schematic diagrams illustrating a minimum angle between a straight line 1 and the semiconductor substrate for protecting an active region according to the first embodiment in which FIG. 3A is the schematic diagram when 1 is 250 [μm] and FIG. 3B is the schematic diagram when 1 is 125 [μm];

FIG. 4 is a cross-sectional view of the optically-coupled device according to the first embodiment illustrating inclinations of the substrate and an optical fiber;

FIG. 5 is a plane view of the substrate according to the first embodiment;

FIG. 6 are schematic views illustrating steps of manufacturing for fixing/positioning the optical fiber to a ferrule according to the first embodiment in which FIG. 6A illustrates a first step, FIG. 6B illustrates a second step, and FIG. 6C illustrates a third step;

FIG. 7 is a cross-sectional view of an optically-coupled device according to a first modified example of the first embodiment illustrating inclinations of a substrate and an optical fiber;

FIG. 8 is a plane view of the substrate according to the first modified example of the first embodiment;

FIG. 9 are views illustrating a light-detecting device according to a second modified example of the first embodiment in which FIG. 9A is a plane view of the light-detecting device and FIG. 9B is a cross-sectional view of the light-detecting device; and

FIG. 10 are enlarged views of a corner portion of the optical fiber according to the first embodiment in which FIG. 10A illustrates the corner portion when chamfering is not performed and FIG. 10B is a schematic view illustrating a state in which the corner portion of the optical fiber is chamfered.

### DETAILED DESCRIPTION

This embodiment is hereinafter described with reference to the drawings. In this description, common reference signs are assigned to common parts throughout the drawings. However, it should be noted that the drawings are schematic ones, so that relationship between a thickness and a flat dimension, a ratio of thickness between layers and the like are different from actual ones. Therefore, specific thickness and dimension should be judged in consideration of a following description. Also, it goes without saying that there is a portion with different relationship of dimensions and ratio among the drawings.

In general, according to one embodiment, an optically-coupled device includes a first optical semiconductor substrate and an optical fiber. The first optical semiconductor substrate inclined from a first direction by a first angle has a first width including a first surface optical device. The optical fiber opposed to the first surface optical device and arranged in a second direction orthogonal to the first direction with an end face has a second angle larger than the first angle with respect to the first direction and having a radius of a second length. An outer edge of the end face opposed to the first optical semiconductor substrate of the optical fiber is chamfered. A difference between the first angle and the second angle is not smaller than the difference with which the first surface optical device is protected from the end face of the optical fiber.

### First Embodiment

An optically-coupled device according to this embodiment is configured to prevent a distal end (hereinafter, also referred to as an end face) of an optical fiber from abutting an active region (circular mesa to be described later) provided on a semiconductor substrate opposed thereto when cutting a distal portion of the optical fiber diagonally with respect to a propagation direction of light and fixing/positioning the optical fiber. Also, it is configured to prevent the optical fiber from getting caught by a ferrule when the optical fiber is inserted into the ferrule, which holds the optical fiber, by chamfering a periphery (outer edge) of the optical fiber, that is to say, a corner of a cladding portion or rounding the corner. Meanwhile, the active region (circular mesa to be described later), which performs optical communication with the optical fiber, is provided on the semiconductor substrate as described above, and this configuration is referred to as a light-emitting (light-detecting) device. In this embodiment, a surface emitting device (for example, vertical cavity surface emitting laser (VCSEL)) is used as the light-emitting (light-receiving) device. A configuration of the VCSEL is to be described later. Also, a case of the light-emitting device is described in this embodiment.

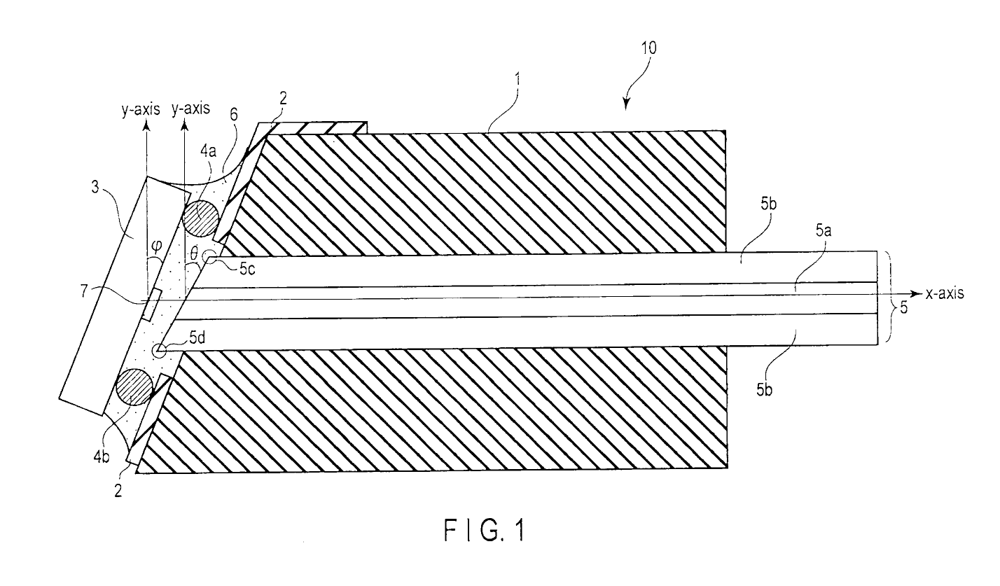

FIG. 1 is a plane view schematically illustrating a configuration of an optically-coupled device 10 according to a first embodiment. The optically-coupled device 10 illustrated in FIG. 1 is provided with a ferrule 1, an electric read frame 2, a light-emitting device 3, a bump for mounting light-emitting device 4, an optical fiber 5 (5a: core and 5b: cladding; when they are not distinguished from each other, simply referred to as the optical fiber 5), and a transparent resin 6.

<Ferrule 1>

The ferrule 1 is capable of holding the optical fiber 5, which guides light, and positions the optical fiber 5. The ferrule 1 is formed by resin molding of an epoxy resin in which approximately 80% glass filler of approximately 30 [μm] is mixed, for example, using a metal mold. Also, a material of the ferrule 1 may be a resin obtained by mixing the glass filler in any one of a polyphenylene sulfide (PPS), a liquid crystal polymer (LCP), a polyamide resin, a silicon resin, an acrylic resin, and a polycarbonate resin in addition to the above-described epoxy resin.

<Electric Read Frame 2>

The electric read frame 2 is formed along a top surface and one side surface of the ferrule 1. Specifically, this is formed along the top surface of the ferrule 1 and the side surface of the ferrule 1 opposed to the light-emitting device 3. The electric read frame 2 is formed by pattern metallization on the ferrule 1 by sputtering and the like with a metal mask. According to this, it is possible to produce in quantity the ferrule 1 provided with the electric read frame 2 at a cost lower than that in a conventional example while maintaining extremely high accuracy of 1 [μm] or smaller.

<Light-Emitting Device 3>

As described above, in this embodiment, an active region 7 is provided on a central portion of a surface of a semiconductor substrate 301. A configuration formed of the semiconductor substrate 301 and the active region 7 is referred to as the light-emitting device 3. Although the VCSEL used as the light-emitting device 3 refers to a full range of vertical resonance surface emitting lasers, this often refers to a vertical distributed Bragg reflector (DBR) surface emitting laser in a limited manner in general. In the light-emitting device 3, which emits light of an oscillation wavelength band of 850 [nm] having relatively broad utility, AlₓGa₁₋ₓAs is used as a DBR mirror. In order to obtain a reflectivity of 99.9% or more, which is required by an oscillation condition, a thickness of approximately 3.5 [μm] obtained by repeatedly laminating layer pairs of Al_{0.1}Ga_{0.9}As/Al_{0.9}Ga_{0.1}As each having a thickness of λ/4, for example, is required. Also, it is required to interpose an active layer by first and second DBR layers 304 and 306 to be described later, so that the thickness of approximately 7 to 8 [μm] is obtained as a whole.

Also, position alignment of the semiconductor substrate 301 and the ferrule 1 is performed using a hole of the ferrule 1, which holds the optical fiber 5. According to this, the semiconductor substrate 301 is mounted on the ferrule 1. Specifically, the position alignment is performed by image recognition of a holding hole of the optical fiber 5. By this position alignment, accuracy of ±5 [μm] or smaller may be ensured.

The active region 7 converts an electric signal transferred from the electric read frame 2 through the bump for mounting light-emitting device 4 to an optical signal and allows the optical fiber 5 to guide the optical signal. Meanwhile, the semiconductor substrate 301 may also be provided with the active region 7, which serves as the light-detecting device to be described later. In this case, the active region 7 receives the optical signal guided by the optical fiber 5, converts the same to the electric signal, and thereafter transfers the electric signal to the electric read frame 2 through the bump for mounting light-emitting device 4. Meanwhile, a structure of the light-receiving device (light-emitting device) is to be described in a second modified example.

<Bump for Mounting Light-Emitting Device 4>

Bumps for mounting light-emitting device 4a and 4b (hereinafter referred to as bumps 4a and 4b, or simply referred to as bump 4 when they are not distinguished from each other) electrically connect the electric read frame 2 to the light-emitting device 3. According to this, the electric signal transferred through the electric read frame 2 and the bump 4 is supplied to the active region 7 and the electric signal transferred from the active region 7 through the bump 4 is supplied to the electric read frame 2 in an opposite manner. Various materials and connecting methods such as a soldering bump (thermal fusion), an Au bump (thermal compression), and a Sn/Cu bump (solid-phase bonding) may be used as the bump 4. Meanwhile, a radius of the hump 4a and that of the bump 4b are identical to each other. That is to say, an inclination of the ferrule 1 and that of the light-emitting device 3 (semiconductor substrate 301) with respect to a y-axis are identical to each other. Herein, the inclination of both of them with respect to the y-axis is set to φ.

<Optical Fiber 5>

The optical fiber 5 is held in the hole for the optical fiber 5 provided on the ferrule 1 and the end face (side opposed to the light-emitting device 3 in FIG. 1) has a surface, which is not perpendicular to a light waveguide direction (x-axis) of the optical fiber 5. An inclination of the end face with respect to the y-axis is set to θ(≠φ). Further, peripheral portions of the optical fiber 5 (specifically, 5c and 5d in FIG. 1) are chamfered. That is to say, the outer edge of the cladding 5b of a surface of a waveguide, which is opposed to the light-emitting device 3 (semiconductor substrate 301) and is exposed in a non-perpendicular direction, is chamfered. Chamfering is performed by medical agent such as hydrofluoric acid or by grind to obtain a desired shape of the end face cut with fiber cleaver and laser in a case of a silica optical fiber and the like. The chamfering in a case of a plastic fiber is performed by the grind or hot plate shaping to obtain the desired shape of the end face cut with knife and laser. Chamfered outer edge portions 5c and 5d may have shapes having a certain curvature radius or may have planar shapes of which corner is cut. The shapes will be described later.

In this embodiment, a silica-based multimode graded index (GI) fiber (core diameter is 50 [μm], cladding diameter is 125 [μm], and NA is 0.21) is used, for example, as the optical fiber 5. Meanwhile, the optical fiber 5 may have the core diameter of 180 [μm] and the cladding diameter of 250 [μm]. Also, a multicomponent glass system optical fiber and a plastic optical fiber may be used as the optical fiber 5 and not only the end face of the optical fiber 5, which is opposed to the light-emitting device 3 (semiconductor substrate 301), but also the end face on an opposite side may also be non-perpendicular to the y-axis.

<Transparent Material 6>

The transparent material 6 has a refractive index closer to that of the optical fiber 5 (refractive index of the optical fiber 5 is 1.46) and is filled in a gap between the optical fiber 5 and the light-emitting device 3. The transparent material 6 is used as an adhesive for adhering an optical device underfill material, the optical fiber 5, and the ferrule 1.

<Detail of Light-Emitting Device 3>

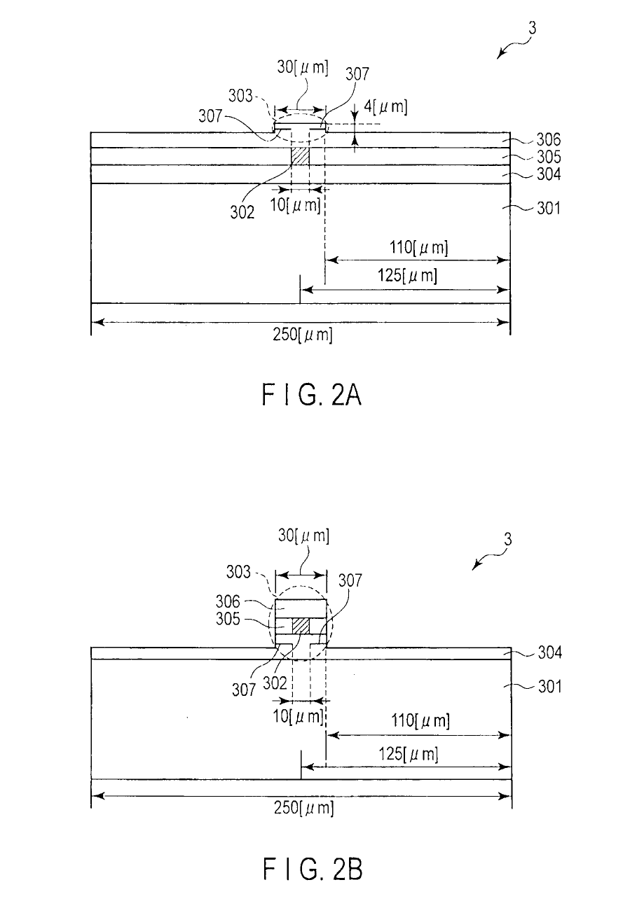

Next, a structure of the light-emitting device 3, that is to say, the semiconductor substrate 301 and the active region 7 formed on the semiconductor substrate 301 is described in detail with reference to FIGS. 2A and 2B. As illustrated in FIG. 2A, in the light-emitting device 3, the semiconductor substrate 301 formed of GaAs, for example, the first DBR layer 304 formed on the semiconductor substrate 301, an active layer 305 formed on the first DBR layer 304, and the second DBR layer 306 formed on the active layer 305 are sequentially formed from below, and a selectively oxidized layer 307 of 10 [μm] is formed in the second DBR layer 306 from both side walls inward.

Also, a circular mesa 303 is formed on a part of the second DBR layer 306. The circular mesa 303 is formed so as to be deeper than the selectively oxidized layer 307 formed in the second DBR layer 306. In other words, the selectively oxidized layer 307 is located on a side surface of the circular mesa 303. The structure is referred to as a selectively oxidized layer structure and is often used in a high-speed VCSEL, as a current confining (oscillating region limiting) structure. A selectively oxidized structure is a structure in which a thin crystal having extremely strong oxidation properties (for example, Al_{0.98}Ga_{0.02}As) is provided in the vicinity of the laser active layer to selectively perform steam oxidation from outside with a desired laser active region left.

A width of the semiconductor substrate 301 is 250 [μm]. This is because an array arrangement at 250 [μm] pitch is used in general as a ribbon fiber in the silica-based optical fiber 5 for optical communication. Therefore, device design of the light-emitting device 3 also is often performed at 250 [μm] pitch so as to conform to the pitch and the device design of this size may be performed without problem in general.

Also, a diameter of the circular mesa 303 is set to 30 [μm]. As described above, the selectively oxidized layer 307 is formed in the circular mesa 303 and this has a width of 10 [μm] from the side surface of the circular mesa 303. According to this, a current injection opening 302 of which radius is 5 [μm] from the center of the circular mesa 303 (non-selectively oxidized region, a black part in the drawing) is formed in the active layer 305. The current injection opening 302 corresponds to the active region 7 of the light-omitting device 3. The region in which the light is guided also corresponds to the active region 7. In other words, regions of the first DBR layer 301, the active layer 305, and the second DBR layer 306 in which the light is guided without the selectively oxidized layer 301 formed in the second DBR layer 306 also correspond to the active region 7. Hereinafter, in both of a case in which only the current injection opening 302 is referred to and a case in which the regions through which the light transmits of the first DBR layer 304, the active layer 305, and the second DBR layer 306 are collectively referred to, they are referred to as the active region 7.

Meanwhile, the semiconductor substrate 301 is not limited to the structure in FIG. 2A. That is to say, as illustrated in FIG. 2B, it is possible to apply mesa etching fabrication to the semiconductor substrate 301 such that a surface of the first DBR layer 304 is exposed. In this case, the selectively oxidized layer 307 is formed in the first DBR layer 304.

<Method of Manufacturing Semiconductor, Substrate 301 and Active Region 7>

Next, a method of manufacturing the semiconductor substrate 301 and the active region 7 formed on the semiconductor substrate 301 is described with reference to FIG. 2A. As illustrated in FIG. 2A, crystal layers such as the first DBR layer 304, the active layer 305, and the second DBR layer 306 are sequentially grown on the semiconductor substrate 301 and thereafter the mesa etching fabrication with the diameter of 30 [μm] is applied to the second DBR layer 306. Specifically, the circular mesa 303 is formed in a partial region of the second DBR layer 306 by etching of an outer region of a circle having the radius of 15 [μm] from the center. At that time, a depth of the mesa etching may be a depth to achieve the selectively oxidized layer 307 and this is formed to have the depth not smaller than 3.5 [μm], which is a DBR thickness, that is to say, approximately 4 [μm]. Subsequently, the active region 7 having a diameter of 10 [μm] of the current injection opening 302 is fabricated by performing selective oxidation of 10 [μm] from both side surfaces of the second DBR layer 306.

<Minimum Inclined Angle>

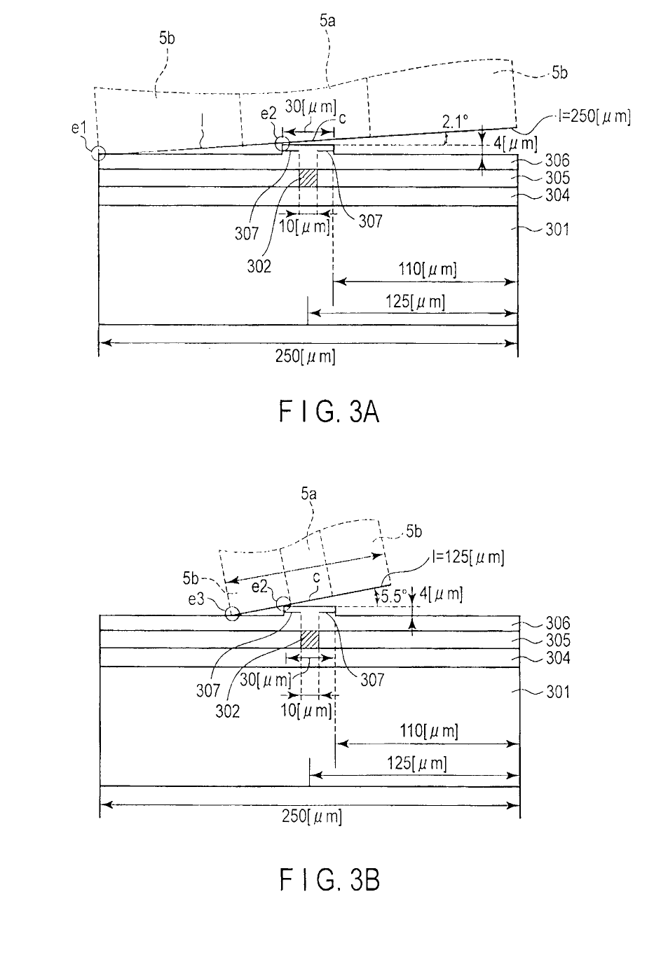

Next, an inclined angle with which the active region 7 is not brought into contact with the end face of the optical fiber 5 is described according to a diameter of the optical fiber 5 with reference to FIGS. 3A and 3B. Hereinafter, it is described supposing that the end face of the optical fiber 5 is a virtual tangential line 1.

(1) Case in which Diameter (2×R) of Optical Fiber 5 is 250 [μm]

As illustrated in FIG. 3A, a 250 [μm]×250 [μm] semiconductor substrate 301 has a distance from a chip edge (point Edge1 (hereinafter, e1 point) in the drawing) to the center of 125 [μm]. Also, when the center of the current injection opening 302 is set on the center of the semiconductor substrate 301, the circular mesa 303 having a height of 4 [μm] is formed to have the radius of 15 [μm] from the center. Therefore, a straight line extending from the chip edge to a mesa edge (e2 point in the drawing) has an inclination of approximately 2.1° with respect to a chip surface (4 [μm]/110 [μm] to tan 2.1°, distance from a chip side to the mesa edge is 110 [μm]).

FIG. 3A illustrates the straight line 1 drawn from an upper left portion of the semiconductor substrate 301 to an upper left portion of the circular mesa 303. As described above, the straight line 1 indicates a surface of a virtual planar contact substance (actually, the end face of the optical fiber 5 perpendicularly cut) and it is supposed that a central point C (center of light axis) of the optical fiber 5 is located on the center of the active region 7. Also, a contact angle between the semiconductor substrate 301 and the straight line 1 is approximately 2.1°.

Therefore, when the angle between the planar contact substance (straight line 1) and the semiconductor substrate 301 is not smaller than 2.1° in FIG. 3A, the optical fiber 5 and the like is not brought into contact with the circular mesa 303 including the active region 7, so that device breaking does not often occur even when there is some contact substances on the surface of the semiconductor substrate 301 (circular mesa 303 and the like). Therefore, the planar contact substance (straight line 1) is first brought into contact with the semiconductor substrate 301 and the active region 7 is protected.

In this manner, in the 250 [μm]×250 [μm] semiconductor substrate 301 corresponding to an array pitch of the general ribbon fiber, the end face of the optical fiber 5 is not brought into contact with the active region 7 included in the circular mesa 303 having the diameter of 30 [μm] when the end face of the optical fiber 5 has the inclination of 2.1° or larger with respect to the semiconductor substrate 301. That is to say, the active region 7 is protected. Therefore, is desirable that the end face from which the light is output of the optical fiber 5 is inclined at 2.1° or larger from a surface on which the surface emitting device is mounted of the ferrule 1.

(2) Case in which Diameter (2×R) of Optical Fiber 5 is 125 [μm]

Next, a case in which the diameter of the optical fiber 5 is set to 125 [μm] is described with reference to FIG. 3B. The structure of the semiconductor substrate 301 illustrated in FIG. 3B is identical to that in FIG. 3A, so that the description thereof is omitted. In this case also, although the straight line 1 indicates the surface of the planar contact substance, this is actually the end face of the optical fiber 5 perpendicularly cut as in the above-described case. Also, it is supposed that the central point C (center of light axis) of the optical fiber 5 is located on the center of the active region 7 provided on the semiconductor substrate 301.

When the end face of the optical fiber 5 of which diameter is smaller than 250 [μm] is opposed to the semiconductor substrate 301, it is required to incline the same at an angle larger than that in the above-described case. For example, as described above, the diameter of a general silica-based optical fiber is often 125 [μm]. In order to protect the circular, mesa 303 provided on the semiconductor substrate 301 and including the active region 7, by performing the position alignment of the above-described semiconductor substrate 301 and the center of the optical fiber 5 having the diameter of 125 [μm], the inclination of approximately 5.0° is required (4 [μm]/47.5 [μm] to tan 5°, distance from an end (point e3) of the optical fiber 5 to the mesa edge (point e2) is 47.5 [μm]). Therefore, it is understood that the optical fiber is first brought into contact with the semiconductor substrate 301 and the circular mesa 303 including the active region 7 is protected when the inclination of the optical fiber is 5° or larger as described above in FIG. 3B.

In the above-described cases (1) and (2), when central positions of the optical fiber 5 and the semiconductor substrate 301 are misaligned, the above-described relationship is not established. However, as is understood from FIG. 1, this problem results in a problem of the position alignment when mounting the semiconductor substrate 301 on the ferrule 1. By further considering accuracy of the position alignment to set the inclined angle of the optical fiber 5, that is to say, an inclined angle of the surface on which the optical device is mounted of the ferrule 1 is 5.5°, the optical fiber is not brought into contact with the active region 7.

<Optimal Value of Optical Fiber 5>

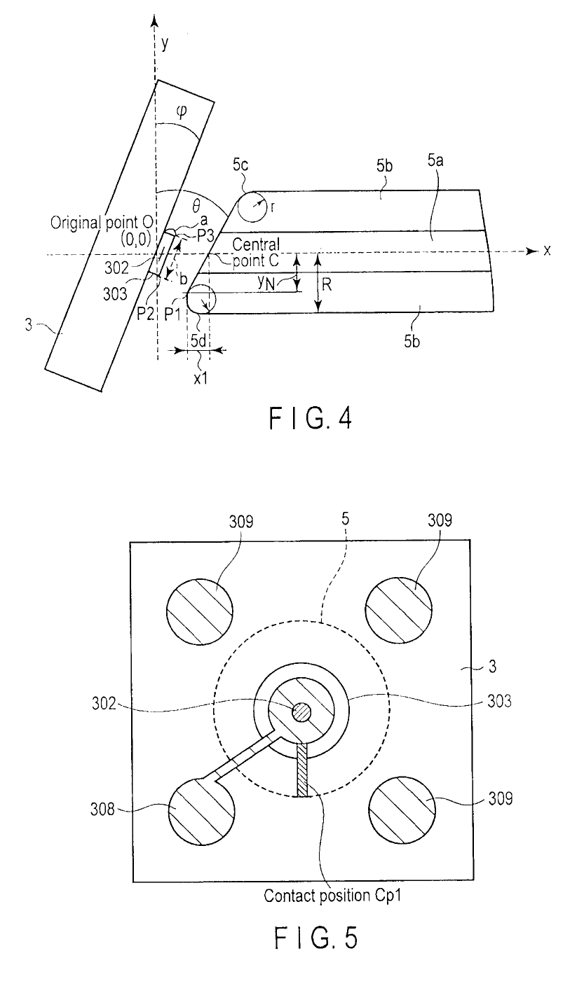

In consideration of the above description, an optimal value of the optical fiber 5 obtained by setting an angular difference |θ−φ| between the light-emitting device 3 and the end face of the optical fiber 5 and each parameter is described with reference to FIG. 4.

As described above, the surface of the light-emitting device 3 (surface of the semiconductor substrate 301) and the light-outputting end face of the optical fiber 5 have different angles. That is to say, in this embodiment, the angles of the light-emitting device 3 and the end face of the optical fiber 5 are such that the relationship of θ≠φ(<θ) is established as described above and the both angles are set such that |θ−φ|≧2.1° is satisfied as the relationship between θ and φ. According to this, the end face of the optical fiber 5 is not brought into contact with the active region 7 included in the circular mesa. That is to say, the active region 7 is protected from the end face of the optical fiber 5.

As illustrated in FIG. 4, an intersecting point of the surface of the semiconductor substrate 301 and the center of the circular mesa 303 (in other words, a coordinate of an end of a line drawn from the center of an upper surface of the circular mesa 303 perpendicularly downward by a depth of the circular mesa) is set to an original point O, and an axis in a perpendicular direction on a plane of paper is set to the y-axis and an axis in a transverse direction on the plane of paper is set to the x-axis. As described above, the inclination of the semiconductor substrate 301, that is to say, the inclination of the ferrule 1 with respect to the y-axis is set to an angle φ and the inclination of the end face to/from which the light inputs/outputs of the optical fiber 5 with respect to the y-axis is set to an angle θ. Also, the height and the diameter of the circular mesa 303 are set to a and b, respectively, and a periphery of the cladding 5b is chamfered with a radius r. Also, a radius of the optical fiber 5 is set to R. Meanwhile, suppose that a y-coordinate on the central point C of the core portion 5a (waveguide) in which the optical signal is guided of the optical fiber 5 is “0”. That is to say, the central point C (center of light axis) of the optical fiber 5 is located on the center of the active region 7 of the semiconductor substrate 301.

Further, on the end face of the optical fiber 5, a position the longest in the light waveguide direction is set to a position 1 (hereinafter, position P1). In a state in which |θ−φ≧2.1° is satisfied, when the end face of the optical fiber 5 is brought closer to the semiconductor substrate 301, the position P1 is the point, which is first brought into contact with the surface of the semiconductor substrate 301.

In this case, when the position P1, which is the distal end of the optical fiber 5, is the closest to the semiconductor substrate 301, a size of the position P1 in a y-axis direction, that is to say, a distance y_{N} from the center of the optical fiber 5 is represented by a following equation (1).

[Equation 1]

y_{N}=−R+r+r sin φ (1)

As represented by the above-described equation (1), when the position P1 is brought closer to the semiconductor substrate 301, the distance y_{N} from the central point C of the optical fiber 5 is determined by the radius R of the optical fiber 5, a chamfering radius r of the periphery (cladding 5b) of the light input/output end of the optical fiber 5, and the angle φ of the ferrule 1 with respect to the y-axis.

When the distance y_{N} is on the outside of the circular mesa 303 provided on the semiconductor substrate 301, that is to say, when the coordinate of the distance y_{N} is set on a position outside of the radius 15 [μm] of the circular mesa 303, the chamfered portions of the peripheral portions 5c and 5d of the light input/output end of the optical fiber 5 are not brought into contact with the circular mesa 303 even when the end face of the optical fiber 5 is brought into contact with the semiconductor substrate 301. That is to say, the chamfered portions of the peripheral portions 5c and 5d of the light input/output end of the optical fiber 5 do not break the active region 7 provided on the semiconductor substrate 301.

Also, when the end face of the optical fiber 5 is brought into contact with the semiconductor substrate 301, the straight line indicating the end face is represented by a following equation (2).

$$\begin{matrix} [ Equation 2 ] & \\ y = \frac{1}{tan θ} x + ( - R + r + r sin θ ) - \frac{1}{tan θ} \{ r ( cos ϕ - cos θ ) + ( - R + r + r sin ϕ ) tan ϕ \} & ( 2 )\end{matrix}$$

On the other hand, distal end coordinates P2(x1, y₁) and P3(x₂, y₂) of the circular mesa 303 are represented by following equations (3) and (4).

$$\begin{matrix}[ Equation 3 ] & \\ ( {x}_{1} , {y}_{1} ) = ( \frac{b}{2} sin ϕ + a cos ϕ , \frac{b}{2} cos ϕ - a sin ϕ ) & ( 3 ) \\ [ Equation 4 ] & \\ ( {x}_{2} , {y}_{2} ) = ( - \frac{b}{2} sin ϕ + a cos ϕ , - \frac{b}{2} cos ϕ - a sin ϕ ) & ( 4 )\end{matrix}$$

By the above-described equations (2), (3), and (4), when the straight line represented by the equation (2) is located on a right side on the x-axis than a line segment connecting the equations (3) and (1), the end face of the light input/output end of the optical fiber 5 is not brought into contact with the circular mesa 303 and this does not break the circular mesa 303 provided on the semiconductor substrate 301 and including the active region 7.

<Case in which Diameter (2×R) of Optical fiber 5 is 250 [μm])>

As described with reference to FIG. 3A, a case in which the diameter of the optical fiber 5 is 250 [μm] is hereinafter described. For example, it is set such that the angle φ is 0°, the angle θ is 2.1° (∴|θ−φ|=2.1°), the radius R is 125 [μm], and the curvature radius r of 5c and 5d is 0 [μm]. Then, the straight line represented by the above-described equation (2) is located on the right side on the x-axis than the line segment connecting the equations (3) and (4). That is to say, the end face of the optical fiber 5 is not brought into contact with the circular mesa 303 provided on the semiconductor substrate 301 and including the active region 7 to break the same.

In this case, a length in an x-direction from the light input/output end (x-coordinate of the central point C) of the center of the optical fiber 5 to the position P1 is approximately 4.6 μm (represented as x1 in the drawing). That is to say, by setting the angle θ and the like of the end face of the optical fiber 5 such that x1 is larger than approximately 4.6 [μm], the end face is not brought into contact with the active region 7. That is to say, the active region 7 is protected from the end face of the optical fiber 5.

From above, in a case of positional relationship between the light-emitting device 3 (semiconductor substrate 301) and the optical fiber 5 as illustrated in FIG. 4, when the y-coordinate of the position P1, that is to say, the distance y_{N} is not smaller than 15 [μm] and the length x1 in the light waveguide direction of the optical fiber 5 from the light input/output end (central point C) on the center of the optical fiber 5 to the position P1 of the distal end of the end face the longest in the light waveguide direction of the optical fiber 5 is not smaller than 4.6 [μm], even when the optical fiber 5 is brought into contact with the semiconductor substrate 301, this is not brought into contact with the circular mesa 303 and this does not break the active region 7 of the semiconductor substrate 301. Meanwhile, although it is set such that the angle φ is 0° and the angle θ is 2.1° in the above-description, when |θ−φ|≧2.1° is satisfied, the angles θ and φ may have optional values.

<Case in which Diameter (2×R) of Optical Fiber 5 is 125 [μm]>

As described with reference to FIG. 3B, a case in which the diameter of the optical fiber 5 is 125 [μm] is hereinafter described. Each set value is as follows. That is to say, it is set such that the angle φ is 0°, the angle θ is 5.5° (∴|θ−φ|=5.5°, the radius R is 62.5 [μm], and the radius r of 5c and 5d is 5 [μm]. Then, x1 is approximately 5.5 [μm]. That is to say, when the diameter is smaller than 250 [μm] in the above-described case and when the peripheral portions (5c and 5d) of the end face of the optical fiber 5 are chamfered with the curvature radius r, it is required to incline at a larger angle. That is to say, the length x1 in the light waveguide direction of the optical fiber 5 from the light input/output end (central point C) of the center of the optical fiber 5 to the distal end of the end face (position P1) the longest in the light waveguide direction of the optical fiber 5 in this case may be further increased.

Meanwhile, values of the distance y_{N} and x1 may be easily calculated by using the above-described equations (1) to (4) as described above. Also, although it is set such that the angle φ is 0° and the angle θ is 5.5° in the above-description, when |θ−φ|≧5.5° is satisfied, the angles θ and φ may have optional values.

<Contact Position of End Face of Optical Fiber 5>

Next, a contact position when the optical fiber 5, which satisfies the above-described condition, is brought into contact with the surface of the semiconductor substrate 301 is described with reference to FIG. 5. FIG. 5 is a plane view of the semiconductor substrate 301. As illustrated, an electrode 308 and three electrodes 309 are formed on the semiconductor substrate 301 around the original point O and the circular mesa 303 is formed on the inside thereof. As described above, the active region 7 is provided on a central portion of the circular mesa 303 and the portion is electrically connected to one of the electrodes 301 by the electric wire. Meanwhile, a dashed line between the circular mesa 303 and the electrodes 308 and 309 indicates the diameter of the optical fiber 5.

When the end face of the optical fiber 5, which satisfies the above-described equations (1) to (4), is brought into contact with the surface of the semiconductor substrate 301, the position is indicated by a black portion as illustrated. This portion is made a contact position Cp1. It is desirable that the electrodes 308 and 309 provided on the semiconductor substrate 301 are not arranged on the contact position Cp1. This prevents disconnection and the like by contact of the optical fiber 5.

<Method of Fixing/Positioning Optical Fiber 5>

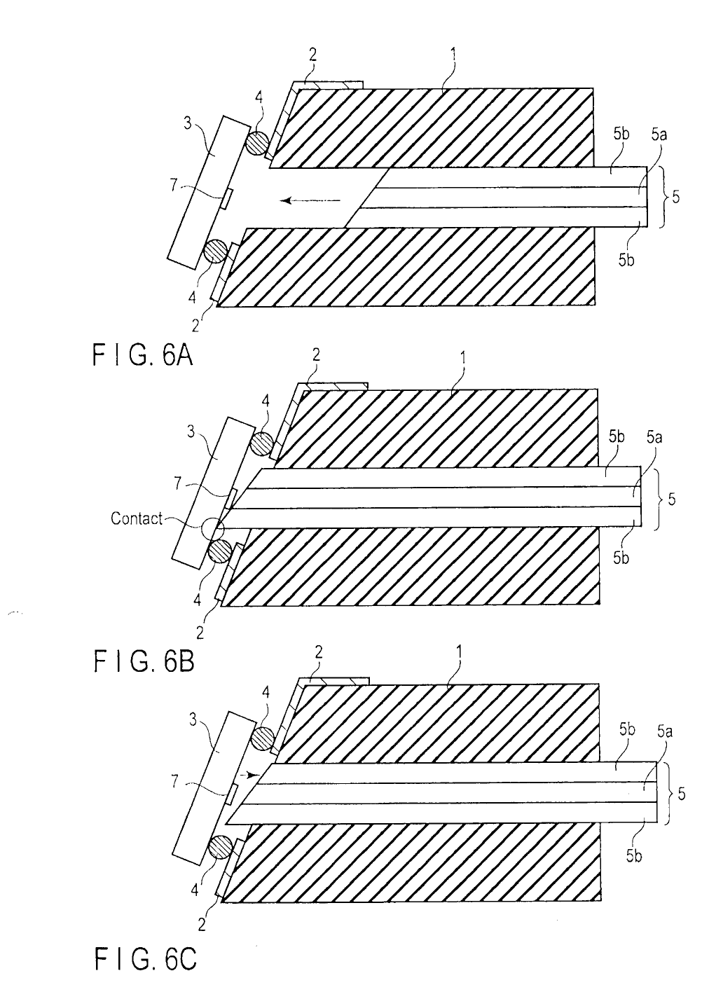

Next, a method of fixing/positioning the optical fiber 5 is described with reference to FIGS. 6A to 6C. First, as illustrated in FIG. 6A, the optical fiber 3 is inserted into the ferrule 1 from a hole on a side opposite to the side opposed to the light-emitting device 3. At that time, even when there is warpage in the optical fiber 5 itself, since 5c and 5d are chamfered, the optical fiber 5 does not get caught in the ferrule 1 and it is possible to smoothly insert the same.

Subsequently, us illustrated in FIG. 6B, the end face of the optical fiber 5, which satisfies the relationship of the above-described equations (1) to (4) with the light-emitting device 3, is brought into contact with the surface of the semiconductor substrate 301. At that time, the end face of the optical fiber 5 is brought into contact with the surface of the semiconductor substrate 301 at the contact position as in FIG. 5 as described above. At that time, since the equations (1) to (4) are satisfied, the end face of the optical fiber 5 is not brought into contact with the circular mesa 303 including the active region.

Thereafter, as illustrated in FIG. 6C, the end face of the optical fiber 5 is taken away from the surface of the semiconductor substrate 301 by a defined distance. According to this, the fixing/positioning of the optical fiber is finished. Meanwhile, when the optical fiber 5 is fixed to the ferrule 1, the above-described step in FIG. 6C may be omitted. That is to say, a state in which the end face of the optical fiber 5 is put on the surface of the semiconductor substrate 301 also is possible.

<Effect According to First Embodiment>

With the optically-coupled device according to this embodiment, following effects (1) to (3) may be obtained.

(1) The Optical Fiber 5 May be Inhibited from Getting Caught.

In the optically-coupled device according to this embodiment, the corners of the cladding portions 5c and 5d of the optical fiber 5 are chamfered as described above. Therefore, when the optical fiber 5 is inserted into a holding portion of the ferrule 1, it is possible to decrease frequency of catch of the distal end of the optical fiber 5 by the portion to hold the optical fiber of the ferrule 1 even when there is slight warpage in the optical fiber 5. Also, it becomes possible to inhibit breaking of the distal end of the optical fiber 5 by the catch. A large part of the above-described catch may be inhibited by setting the curvature radius r of the chamfering of the peripheral portions 5c and 3d of the end face of the optical fiber 5 to approximately 5 [μm] or larger although this depends on irregularity of the portion to hold the optical fiber 5 of the ferrule 1 and a shape of warpage of the optical fiber 5.

Further, it becomes possible to inhibit “grind” of the portion to hold the optical fiber 5 of the ferrule 1 by the catch of the optical fiber. Therefore, “shaving” is not generated between the light-emitting device 3 and the optical fiber 5, so that it becomes possible to inhibit deterioration in optical coupling characteristics between the light-emitting device 3 and the optical fiber 5.

Also the chamfering of the peripheral portions 5c and 5d of the end face of the optical fiber 5 has an effect to inhibit the breaking and the like of the light-emitting device 3 by the optical fiber 5 when this is brought into contact with the surface of the semiconductor substrate 301.

(2) Generation of Noise May be Inhibited.

In the optically-coupled device according to this embodiment, the light input/output end face of the optical fiber 5 and the light-emitting device 3 are optically coupled to each other with a certain inclined angle. Therefore, there is an effect of inhibiting generation of noise by feedback light.

However, since a distance from a light output surface of the light-emitting device 3 to the light input end face of the optical fiber 5 is extremely short such as approximately 2 [μm] in this embodiment, there is a case in which reflected light from the end face of the optical fiber 5 is coupled with a light resonance mode of the light-emitting device 3 to generate feedback light noise even though the optical fiber 5 and the light-emitting device 3 are inclined at the angle of |θ−φ|.

In order to inhibit, this problem, the transparent resin 6 is filled in the gap between the optical fiber 5 and the light-emitting device 3 in this embodiment. The refractive index of the transparent resin 6 has a value closer to that of the optical fiber 5. According to this, it becomes possible to decrease a difference in refractive index between the optical fiber 5 (refractive index is approximately 1.46) and an environment (refractive index is approximately 1 in a case of air). Therefore, it is possible to keep extremely near end reflected light from the end face of the optical fiber 5 (reflected distance of a few [μm]) low. This is because an effect similar to that of a case in which the optical fiber is kept away from the light-emitting device may be obtained equivalently by decrease in the reflectivity by the decrease in the difference in refractive index. From above, it is desirable that the refractive index of the transparent resin 6 is equal to or substantially equivalent to an equivalent refractive index of the optical fiber 5.

Also, to fill the transparent resin 6 has an effect of inhibiting minute vibration of the optical fiber 5 by external force. The optical fiber 5 is in contact with various substances on the outside of the optically-coupled device and this might be a medium to transmit the external force from them inside; when the optical fiber 5 is subject to external periodical vibration and when the vibration is in the vicinity of mechanical resonance frequency, there is a case in which internal resonance vibration in which the end face of the optical fiber 5 or the light-emitting device 3, which is in contact with the same, minutely vibrates occurs. To fill the transparent resin 6 as described above is also effective to prevent or attenuate such internal vibration.

Further, the transparent resin 6 also has an effect to decrease the difference in thermal expansion characteristics between the semiconductor substrate 301 and the ferrule 1, and this has an effect of distributing stress and strain generated by difference in thermal expansion coefficient of both of them to an entire surface of the light-emitting device 3 in which the active region 7 is provided on the semiconductor substrate 301 without concentrating the same on a connecting portion (periphery of the bump for mounting light-emitting device 4) of the light-emitting device 3 and the ferrule 1. Therefore, to fill the transparent resin 6 is also effective for preventing deterioration in thermal cycle and the like.

In order to further improve the above-described effect, it is also effective to mix a transparent particle filler (silica and crushed quartz having a mean particle diameter of a few [μm] to tens of [μm], for example) in the transparent resin 6. That is to say, by matching mean/equivalent thermal expansion characteristics of the resin to that of the optical fiber and the light-emitting device 3 or setting the same to a value intermediate therebetween by adjusting a mixture ratio of the transparent particle filler, it is possible to improve an effect to relax a thermal stress (thermal strain).

Meanwhile, it is also possible to set the angle of the light-emitting device 3 in a direction perpendicular to the light waveguide direction of the optical fiber 5, that is to say, φ=0. However, in this case, since the transparent resin 6 is filled, there is a possibility that the reflected light from the optically-coupled device (for example, PD) on the side opposite to the end face of the optical fiber 5 opposed to the light-emitting device 3, that is to say, the other end of the optical fiber 5 is incident on the light-emitting device 3 to generate the noise by the feedback light. In order to inhibit this, it is desirable to incline the light-emitting device 3 by the angle φ from the direction perpendicular to the light waveguide direction of the optical fiber 5. That is to say, it is preferable that θ>0° is satisfied.

(3) Distance Between Light-Emitting Device 3 (Semiconductor Substrate 301) and Optical Fiber 5 May be Made Constant.

According to the optically-coupled device according to this embodiment, when fixing the optical fiber 5 to the ferrule 1 to position the same, the end face of the optical fiber 5, that is to say, the position P1 is once put on the surface of the semiconductor substrate 301 and thereafter this is taken back by a certain distance. That is to say, the position at which the end face of the optical fiber 5 is brought into contact with the surface of the semiconductor substrate 301 is made a reference and by taking the same away from a contact point by a defined distance, the distance between the light-emitting device 3 and the optical fiber 5 may be made constant. In other words, by setting how much the optical fiber 5 is taken back from the semiconductor substrate 301 from the contact position (reference point), it is possible to prevent an individual difference between the optically-coupled devices from generating.

### First Modified Example

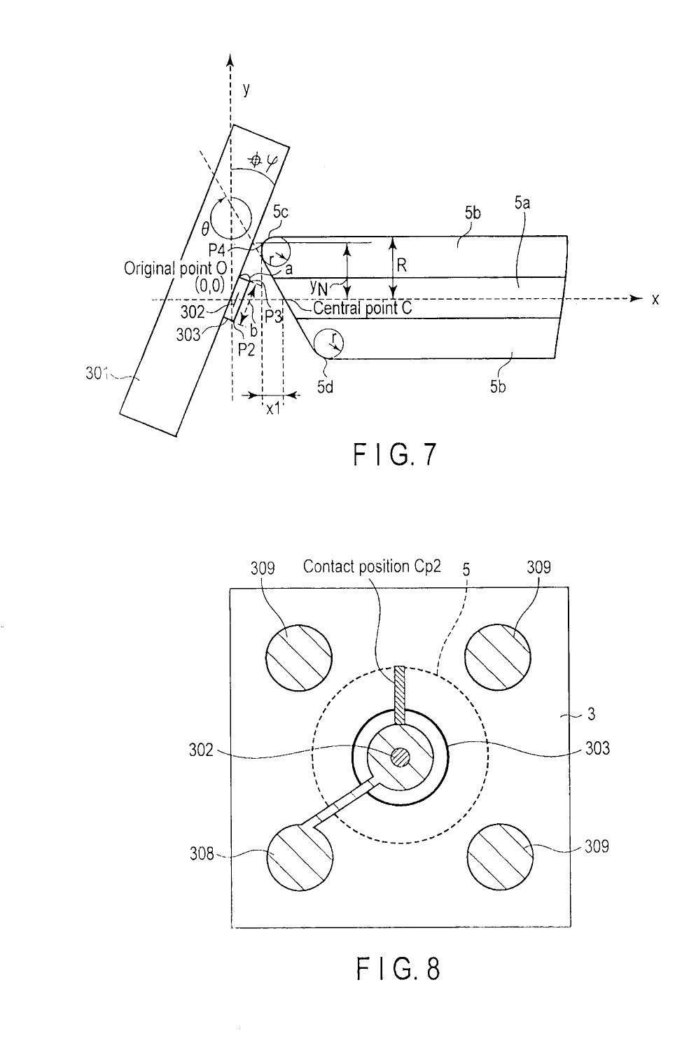

Next, an optically-coupled device according to a first modified example of the above-described first embodiment is described with reference to FIGS. 7 and 8. The optically-coupled device according to the first modified example is obtained by inverting an optical fiber 5 in the above-described first embodiment about an x-axis. That is to say, a y-coordinate of a position P1 is located on a positive side. This is hereinafter referred to as a position P4. Meanwhile, as in the above-described first embodiment, an angular difference between an end face of the optical fiber 5 and a light-emitting device 3 is set such that |θ−φ|≧2.1° is satisfied and the description of a configuration identical to that of the above-described first embodiment is omitted.

Hereinafter, in the optically-coupled device according to the first modified example, a condition for a circular mesa 303 including an active region 7 to be protected from the end face of the optical fiber 5 when the optical fiber 5 is held by a ferrule 1 is described. In the first modified example, a value of the y-coordinate of the position P4, that is to say, a distance y_{N} is represented by a following equation (5).

[Equation 5]

y_{N}=R−r+r sin φ (5)

As in the above-described equation (1), in the above-described equation (5), when the position P4 is brought closer to a semiconductor substrate 301, the distance y_{N} from a central point C of the optical fiber 5 is determined by a radius R of the fiber 5, a curvature radius r with which peripheral portions 5c and 5d of a light input/output end of the optical fiber 5 are chamfered, and an angle φ of the ferrule 1.

When a position y_{N} is on the outside of the circular mesa 303, that is to say, when the distance y_{N} is set on a position outside of a radius of 15 μm of the circular mesa 303, 5c and 5d in a chamfered cladding 5b are not brought into contact with the circular mesa 303 even when the optical fiber 5 is brought into contact with a surface of the semiconductor substrate 301. That is to say, the circular mesa 303 provided on the semiconductor substrate 301 and including the active region 7 is not broken.

Also, in the first modified example, when the end face of the optical fiber 5 is brought into contact with the surface of the semiconductor substrate 301, a straight line indicating the end face is represented by a following equation (6).

$$\begin{matrix} [ Equation 6 ] & \\ y = \frac{1}{tan θ} x + ( R - r + r sin θ ) - \frac{1}{tan θ} \{ r ( cos ϕ - cos θ ) + ( R - r + r sin ϕ ) tan ϕ \} & ( 6 )\end{matrix}$$

On the other hand, distal end coordinates P2(x1, y₁) and P3(x₂, y₂) of the circular mesa 303 are represented by the above-described equations (3) and (4).

By the equations (3), (4), and (6), when the straight line represented by the equation (6) is located on a right side on an x-axis than a line segment connecting the equations (3) and (4), the end face of the optical fiber 5 is not brought into contact with the circular mesa 303. That is to say, even when the end face of the optical fiber 5 is brought into contact with the surface of the semiconductor substrate 301, the circular mesa 303 including the active region 7 is protected from the end face of the optical fiber 5 and it is possible to prevent breaking.

<Case in which Diameter (2×R) of Optical Fiber 5 is 250 [μm])>

Hereinafter, a case in which a diameter of the optical fiber 5 is 250 [μm] is described as described with reference to FIG. 3A in the above-described first embodiment. For example, it is set such that the angle φ is 2.1°, an angle θ is 0°, the radius R is 125 [μm], and the curvature radius r is 0 [μm].

In this case, the straight line represented by the equation (6) is located on the right side on the x-axis than the line segment connecting the equations (3) and (4). That is to say, a distal end of the optical fiber 5 is not brought into contact with the circular mesa 303 provided on the semiconductor substrate 301 and including the active region 7 to break the same as described above.

In this case, a length from the light input/output end (x-coordinate of the central point C) of the center of the optical fiber 5 to the x-coordinate of the position P4 is 0.0 [μm] (represented as x1 in the drawing). That is to say, by setting the angle θ and the like of the light input/output end face of the optical fiber 5 such that x1 is larger than 0.0 [μm], the end face is not brought into contact with an active region 302. That is to say, the circular mesa 303 including the active region 7 is protected from the light input/output end face of the optical fiber 5.

From above, in a case of positional relationship between the light-emitting device 3 and the optical fiber 5 as illustrated in FIG. 7, when the y-coordinate of the position P4, that is to say, the distance y_{N} is not smaller than 15 [μm] and the length in an x-axis direction from the central point C of the optical fiber 5 to the position P4 of the distal end of the end face the longest in a light waveguide direction of the optical fiber 5 is not smaller than 0.0 [μm], even when the optical fiber 5 is brought into contact with the surface of the semiconductor substrate 301, the end face of the optical fiber 5 is not brought into contact with the circular mesa 303. That is to say, the distal end of the optical fiber 5 does not break the circular mesa 303 provided on the semiconductor substrate 301 and including the active region 7.

<Case in which Diameter (2×R) of Optical Fiber 5 is 125 [μm]>

Hereinafter, a case in which the diameter of the optical fiber 5 is 125 [μm] is described. That is to say, it is set such that the angle φ is 7.5°, the angle θ is 2.0°) (∴|θ−φ|=5.5°, the radius R is 62.5 [μm], and the radius r of 5c and 5d is 5 [μm]. Then, x1 is approximately 2.0 [μm]. That is to say, when the diameter is smaller than 250 [μm] in the above-described case and when the peripheral portions (5c and 5d) of the end face of the optical fiber 5 are chamfered with the radius r, it is required to incline at a larger angle. That is to say, the length in the x-axis direction from the light input/output end (central point C) of the center of the optical fiber 5 to the distal end (position P4) of the end face the longest in the light waveguide direction of the optical fiber 5 may be further increased.

From above, in a case of the positional relationship between the light-emitting device 3 and the optical fiber 5 as illustrated in FIG. 7, when the y-coordinate of the position P4, that is to say, the distance y_{N} is not smaller than 15 [μm] and the length in the x-axis direction from the central point C of the optical fiber 5 to the position P4 is not smaller than approximately 2.0 [μm], even when the optical fiber 5 is brought into contact with the surface of the semiconductor substrate 301, the optical fiber 5 is not brought into contact with the circular mesa 303 and does not break the circular mesa 303 provided on the semiconductor substrate 301 and including the active region 7.

As described above, values of the distance y_{N} and x1 may be easily calculated by using the above-described equations (3) to (6) even in the first modified example.

<Contact Position of End Face of Optical Fiber 5>

Next, a contact position when the end face of the optical fiber 5, which satisfies the above-described condition, is brought into contact with the surface of the semiconductor substrate 301 is described with reference to FIG. 8. FIG. 8 is a plane view of the light-emitting device 3. Hereinafter, a configuration identical to that in FIG. 5 is not described.

When the end face of the optical fiber 5, which satisfies the above-described equations (3) to (6), is brought into contact with the surface of the semiconductor substrate 301, the position is indicated by a black portion as illustrated. This portion is made a contact position Cp2. It is desirable that an electrode 401 provided on the semiconductor substrate 301 is not arranged on the contact position Cp2. This prevents disconnection and the like by contact of the optical fiber 5.

<Effect According to First Modified Example>

With the optically-coupled device according to the first modified example also, the same effects as those in the above-described first embodiment may be obtained. That is to say, the above-described effects (1) to (3) may be obtained. That is to say, when the ferule 1 is allowed to hold the optical fiber 5, it is possible to inhibit catch due to warpage of the optical fiber 5 and to inhibit generation of shaving in the ferrule 1, thereby inhibiting deterioration in optical coupling characteristics.

Also, a transparent resin 6 is filled between the optical fiber 5 and the light-emitting device 3. Therefore, it is possible to inhibit generation of noise by feedback light.

### Second Modified Example

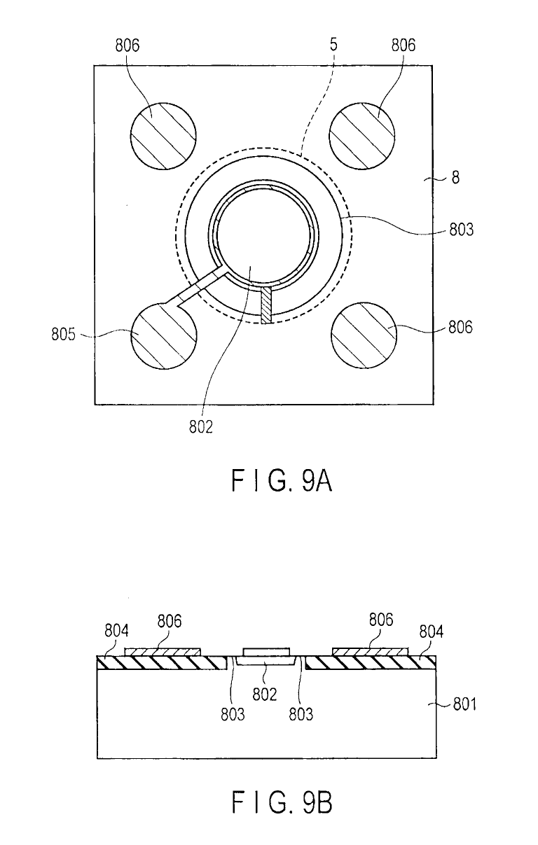

Next, an optically-coupled device according to a second modified example of the above-described first embodiment is described with reference to FIGS. 9A and 9B. In the second modified example, a case in which a light-detecting device such as a PIN-PD is provided as a surface optical device in place of a light-emitting device 3 used in the above-described first embodiment and the first modified example. A semiconductor substrate on which the light-receiving device according to the second modified example is mounted is referred to as a substrate 8.

FIGS. 9A and 95 illustrate a structure of a light-receiving device 3 (hereinafter, referred to as the PIN-PD or the light-receiving device 3) in which FIG. 9A is a plane view of the PIN-PD and FIG. 9B is a cross-sectional view of the PIN-PD.

As illustrated in FIGS. 9A and 9B, an inverted impurity diffusion region (light-receiving unit pn junction) 802 and an insulating film 804 are formed in a surface of a semiconductor substrate 801. A circular mesa 803 is formed around the inverted impurity diffusion region 802. Also, an active region electrode 805 and a grounding electrode 806 are formed on the insulating film 804. Herein, a structure in FIGS. 9A and 95 is hereinafter referred to as the light-receiving device 3. Meanwhile, a broken line in FIG. 9A indicates an opposed position of the optical fiber 5.

The circular mesa 803 serves as an active region. The circular mesa 803 has a function as a diffusion preventing groove of a minority carrier to prevent the minority carrier (positive hole when a non-diffusion region is n type) from diffusing by carrier concentration gradation to reach an adjacent device when the light-receiving device forms an array and the like. Also, in a case of a PIN structure using a direct transition type semiconductor material, a depth of the impurity diffusion region is often approximately 1 [μm] and a thickness of a light absorbing layer is often 2 to 3 [μm], so that a depth of the minority carrier diffusion preventing groove may be set to approximately 4 [μm].

The insulating film 804 is a thick insulating material to decrease a parasitic capacitance of the electrode for device high-speed operation, and a polyimide film having a thickness of 4 [μm] is used, for example. Herein, although it is an active part electrode 805, which is a portion of which electrode capacitance should be decreased using the thick insulating film 804, it is desirable that all bumps 4 have equivalent structures and sizes in consideration of the purpose of this embodiment, and the grounding electrode 806 also has the same configuration as the active part electrode.

Therefore, an entire device has a substantially flat surface and it is configured such that a mechanical configuration as an electrode pad of the bump 4 is the same although a function differs according to whether a wire pattern is connected to the circular mesa 803 (active region 803) or to the light-receiving device 3 through the thick insulating film 804 (not illustrated).

Therefore, in the case of the light-receiving device 3, a portion in which a depleted layer extends from a junction for applying an electric field to a light-receiving layer (light-receiving unit) and a region enclosing a periphery thereof become the active region 803, and in general, a region enlarged by 10 to 20 [μm] circumferentially from the light-receiving unit or a mesa region 803 obtained by fabricating such that the light-receiving unit is separated from the periphery are intended to mean the active region. Therefore, a position of a distal end of the optical fiber 5 and the like may be set such that the optical fiber 5 is not brought into contact with the active region.

<Effect According to Second Modified Example>

The optically-coupled device according to the second modified example may also obtain the above-described effects (1) to (3). That is to say, in a case in which the light-receiving device 3 is used also, the circular mesa 803 (active region 803) is protected from an end face of the optical fiber 5 by optimizing an arranging position relative to the optical fiber opposed thereto and an angle between the light-receiving device 3 and the optical fiber 5 and the like.

### Third Modified Example

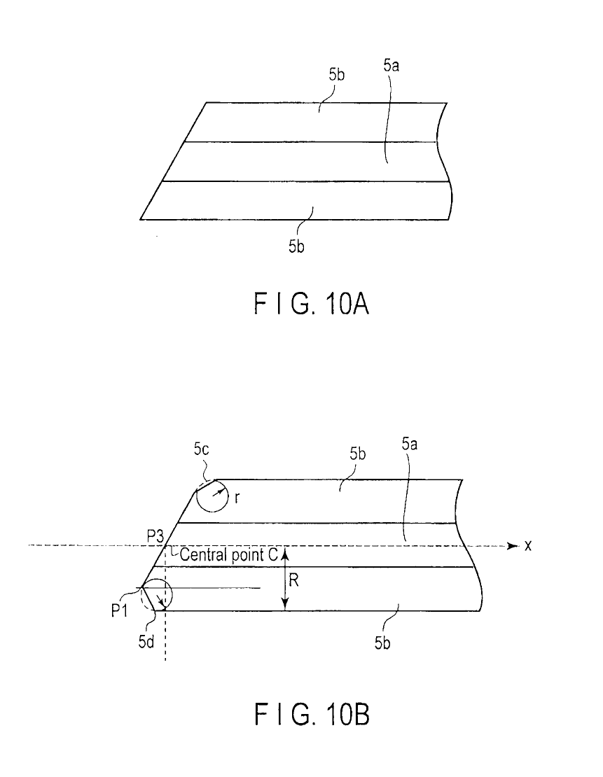

Next, an optically-coupled device according to a third modified example of the first embodiment is described with reference to FIG. 10. The optically-coupled device according to the third modified example is obtained by changing shapes of corner portions 5c and 5d of a cladding 5b from a shape having a curvature radius of a radius r (r is an optional value) to a shape in which points at which a curvature starts are connected by a straight line in this shape.

FIGS. 10A and 10B are enlarged views of the cladding 5b. Herein, FIG. 10A illustrates a case in which the corner portions (5c and 5d) of the cladding 5b are not chamfered and FIG. 10B illustrates a case in which the corner portions of the cladding 5b are chamfered. Meanwhile, the shape of the cladding 5b having the curvature radius r is indicated by a dashed line.

As illustrated in FIG. 10B, the corner portion in FIG. 10A may have a shape in which both starting points S1 and S2 at which the curvature starts are connected by the straight line by chamfering of the cladding 5b. In other words, a shape in which two corners are generated from existing one corner at the corner portion by the chamfering of the cladding 5b is also possible. Meanwhile, positions of the starting points S1 and S2 are the same when the corner portion of the cladding 5b is curved or when this has the shape in which S1 and S2 are connected by the straight line. That is to say, the starting point S1 or S2 is the point the closet to a surface of a semiconductor substrate 301.

### Second Embodiment

Next, an optically-coupled device according to a second embodiment is described. The optically-coupled device according to the second embodiment is obtained by combining the above-described first embodiment and the above-described second modified example. That is to say, the optically-coupled device described in the first embodiment (hereinafter, referred to as a first optically-coupled device) is provided on one end of an optical fiber 5 and a light-receiving device 3 such as a PIN-PD and the like described in the second modified example (hereinafter, referred to as a second optically-coupled device) is provided on the other end thereof. According to this, it becomes possible to transfer an electric signal from the first optically-coupled device to the second optically-coupled device.

Meanwhile, the invention of the present application is not limited to the above-described embodiment and may be variously modified in a practical phase without departing from the spirit thereof. Further, the inventions in various phases are included in the above-described embodiments and the various inventions may be extracted by appropriate combination of a plurality of disclosed components. For example, even when some components are deleted from all the components described in the embodiment, if the problem described in the section of “problem to be solved by the invention” and the effect described in the section of “effects of the invention” are obtained, the configuration without the components may be extracted as the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optically-coupled device, comprising:
a first optical semiconductor substrate inclined from a first direction by a first angle having a first width including a first surface optical device; and
an optical fiber opposed to the first surface optical device and arranged in a second direction orthogonal to the first direction with an end face having a second angle larger than the first angle with respect to the first direction and having a radius of a second length, wherein
an outer edge of the end face opposed to the first optical semiconductor substrate of the optical fiber is chamfered and
a difference between the first angle and the second angle is not smaller than the difference with which the first surface optical device is protected from the end face of the optical fiber.

2. The device according to claim 1, wherein,
when a diameter of the optical fiber is identical to the first width, the difference between the first angle and the second angle is 2.1° or larger, and
when the diameter of the optical fiber is a half of the first width, the difference between the first angle and the second angle is 5.5° or larger.

3. The device according to claim 1, wherein
the optical fiber includes a core portion and a cladding portion covering a periphery of the core portion,
when the optical fiber is brought into contact with a surface of the first optical semiconductor substrate, a distance between a coordinate in the second direction of the cladding, which is in contact with the surface, and the coordinate in the second direction of the center of the core portion on the end face is 4.6 [μm] or larger, and
the distance between the coordinate in the first direction of the center of the core portion and the coordinate in the first direction of the cladding, which is in contact with the surface, is larger than a width of the first surface optical device.

4. The device according to claim 1, wherein
the first optical semiconductor substrate is provided with a first DBR layer, an active layer, and a second DBR layer sequentially formed from below on the semiconductor substrate, and
a part of the active layer serves as an active region.

5. The device according to claim 4, wherein
the first surface optical device is formed on the first optical semiconductor substrate by etching of a part of the second DBR layer or a part of the first DBR layer, the active layer, and the second DBR layer.

6. The device according to claim 4, wherein
the active region is provided in the active layer and in a region, which is not blocked by a selectively oxidized layer formed from both side surfaces of the first DBR layer or the second DBR layer inward.

7. The device according to claim 1, wherein
an end face on a side opposite to the end face of the optical fiber is also made non-perpendicular to the first direction.

8. The device according to claim 1, further comprising: a second optical semiconductor substrate, which optically couples on an end face on an opposite side of the optical fiber, the second optical semiconductor substrate including a second surface optical device, wherein
the second surface optical device serves as a light-receiving device when the first surface optical device serves as a light-emitting device.

9. The device according to claim 1, wherein
a resin having a refractive index closer to the refractive index of the optical fiber is filled between the first optical semiconductor substrate and the end face of the optical fiber.

10. An optically-coupled device, comprising:
a first optical semiconductor substrate provided with a first surface optical device having a height h from a surface and having a length l1 from an end portion to one side surface of the first surface optical device; and
an optical fiber of which end face is opposed to the first surface optical device and of which diameter has a length l₂, wherein
an outer edge of the end face of the optical fiber is chamfered,
when the optical fiber is brought into contact with the surface of the first optical semiconductor substrate, an inclined angle of the end face with respect to the first optical semiconductor substrate when the optical fiber is brought into contact with a part of the surface with the first surface optical device being protected is set to tan⁻¹(h/l₁) or larger when the length l₂ is identical to a width of the first optical semiconductor substrate and is set to tan⁻¹(h/l₃) or larger when a length from a position at which the optical fiber is brought into contact with the surface to the one side surface is set to l₃ when the length l₂ is smaller than the width of the first optical semiconductor substrate.

11. The device according to claim 10, wherein
the optical fiber includes a core portion and a cladding portion covering a periphery of the core portion, when the optical fiber is brought into contact with the surface of the first optical semiconductor substrate, a distance between a coordinate in a second direction of the cladding, which is in contact with the surface, and the coordinate in the second direction of the center of the core portion on the end face is 4.6 [μm] or larger, and
the distance between the coordinate in a first direction of the center of the core portion and the coordinate in the first direction of the cladding, which is in contact with the surface, is larger than a width of the first surface optical device.

12. The device according to claim 10, wherein
the first optical semiconductor substrate is provided with a first DBR layer, an active layer, and a second DBR layer sequentially formed from below on the semiconductor substrate, and
a part of the active layer serves as an active region.

13. The device according to claim 12, wherein
the first surface optical device is formed on the first optical semiconductor substrate by etching of a part of the second DBR layer or a part of the first DBR layer, the active layer, and the second DBR layer.

14. The device according to claim 12, wherein
the active region is provided in the active layer and in a region, which is not blocked by a selectively oxidized layer formed from both side surfaces of the first DBR layer or the second DBR layer inward.

15. The device according to claim 10, wherein
an end face on a side opposite to the end face of the optical fiber is made non-perpendicular to a first direction.

16. The device according to claim 10, further comprising:
a second optical semiconductor substrate, which optically couples on an end face on an opposite side of the optical fiber, the second optical semiconductor substrate including a second surface optical device, wherein
the second surface optical device serves as a light-receiving device when the first surface optical device serves as a light-emitting device.

17. The device according to claim 10, wherein
a resin having a refractive index closer to the refractive index of the optical fiber is filled between the first optical semiconductor substrate and the end face of the optical fiber.

18. A method of fixing an optically-coupled device, comprising:
inserting an optical fiber of which end face is cut at a second angle larger than a first angle from a first direction into a holding portion of a ferrule toward an optical semiconductor substrate of which surface is inclined at the first angle from the first direction with a surface optical device provided on the surface;
inserting the optical fiber until the end face of the optical fiber abuts the surface; and
taking away the end face of the optical fiber by a certain distance from the surface after the end face of the optical fiber abuts the surface.

19. The method according to claim 18, comprising:
setting a difference between the first angle and the second angle to 2.1° or larger when the optical semiconductor substrate has a first width, the optical fiber has a radius of a second length, and a diameter of the optical fiber is identical to the first width; and
setting the difference between the first angle and the second angle to 5.5° or larger when the diameter of the optical fiber is a half of the first width.

20. The method according to claim 18, comprising filling a resin having a refractive index closer to the refractive index of the optical fiber between the optical semiconductor substrate and the end face.
